(19) United States
(12) Patent Application Publication
(10) Pub. No.: US 2012/0204553 A1
(43) Pub. Date: Aug. 16, 2012

(54) Pressure Transformation Method and Device for its Implementation

(76) Inventor: Mikko Junttila, Hiltulanlahti (FI)

(21) Appl. No.: 13/502,961

(22) PCT Filed: Oct. 20, 2010
(86) PCT No.: PCT/FI2010/050825

§ 371 Date: Apr. 23, 2012

(30) Foreign Application Priority Data
Oct. 20, 2009 (FI) 20090383

(51) Int. Cl. F15B 11/032; F15B 7/00; F15B 3/00

(52) U.S. Cl. 60/563; 60/560; 60/581

(57) ABSTRACT

A method for transforming pressures of a system operating with pressure medium to optimize the travel speeds and/or forces of tasks utilizing pressure, area and flow ratios, employing valve structures, in which method, transforming with pressure transformers the pressure of the actuators differ from system pressure. A device implementing the method includes valve structures and pressure transformers. In the method, pressure transformers are switched when going above or below a set limit value controlling valves of actuators which requires the transformation of travel speed or force. In the device, pressure transformers are arranged to be switched when going above or below a set limit value controlling the valves for the actuator which requires higher travel speed or force.

### CROSS-REFERENCE TO RELATED APPLICATIONS

This application is a National Stage application of International Application No. PCT/FI2010/050825, filed Oct. 20, 2010, which claims benefit to Finnish Application No. 20090383, filed Oct. 20, 2009, which are incorporated by reference herein in their entirety.

### BACKGROUND

1. Field

The invention relates to a method for transforming pressure in a system operating with pressure medium defined in the preamble of claim 1 and a device for implementing the method defined in the preamble of the first device claim.

2. Description of the Related Art

Typically, particularly hydraulic systems are accustomed to employ only system pressure, which is produced in the system with one or more pumps. A current trend in development is to use higher pressures, whereby smaller cylinders provide the same force as larger cylinders and lower pressures did earlier. It is also possible to keep travel speeds the same as previously by using lower flow rates and smaller cylinders. For example, the set of booms of an excavator or a forest machine is provided lighter and slenderer when the cylinders and their hosings and tubings are smaller. All high-pressure components in a high-pressure system increase manufacturing and maintenance costs. The usability of high-pressure systems is limited and their efficiency is weakened particularly by flow resistances generated in long medium transfer lines with high pressure and high flow rate. Using higher pressure in a system is also a safety risk and it shortens the lifetime of pumps and other system components compared to a system using lower pressure. High-pressure also prerequisites more expensive pumps and more expensive components used in medium transfer lines and control, such as valves, hoses and connectors, compared to systems of lower pressure. In many applications, high force is only required momentarily and/or for a portion of the cylinder stoke and/or for the travel of the cylinder piston in one direction. However, the size of the cylinder is dimensioned in accordance with the highest force required, whereby the travel becomes slow even in that travel portion which does not require high force. Often, locating a cylinder dimensioned in accordance with the highest force required in a confined structure is also difficult. Of prior art are known variable-volume cylinders, such as cylinders of telescopic structure, the most well-known application of which is perhaps the tipping cylinder of a lorry or a truck, but these cylinders also require the same oil volume to open irrespective of load and the highest force with the cylinders in question is always at the start of the travel when the area of the cylinder is at its largest. Furthermore, the cylinders in question are usually single-acting.

It is also known to increase pressure with expensive pump arrangements of various types, which provide even high booster factors, but their efficiency is generally poor and they are extremely sensitive to tiny impurities. Additionally, locating them in confined structures is often difficult. Known are also high-speed valves which can increase the travel speed of the cylinder piston for the travel portion having no high force requirement by controlling oil flow exiting the cylinder in addition to the flow entering the cylinder. Such a high-speed valve is commonly used e.g. in firewood processors. The operation of the high-speed valve in question is more effective if the ratio of areas of the cylinder is small, but then the return travel of the piston is equivalently slower due to the larger volume and the buckling risk of the cylinder increases. It is also a known problem that, in an existing hydraulic system, the pressure coming from e.g. a tractor is not sufficient to drive various devices designed for higher pressures, such as guillotine shears. Furthermore, the flow volume of the existing system being low, the speeds of travels requiring high momentary force are slow due to having been dimensioned in accordance with the highest force required.

### SUMMARY

The object of the invention is indeed to eliminate the above disadvantages and to introduce a novel kind of a pressure transformation method and a device for implementing the pressure transformation method.

The object of the invention is achieved with a method and a device which are characterised by what is presented in the claims.

The method and the device implementing it for transforming pressure are realisable with a small number of components and with a reliable operating principle. The small number of components is also directly reflected in the price, weight, ease of use and reliability of operation of the pressure transformer.

Furthermore, pressure transformers according to the invention are easy to locate in the vicinity of one or more machine elements, e.g. a hydraulic cylinder, requiring pressure and/or flow transformed of the system pressure and/or to engineer in one or more machine elements requiring transformed pressure to be connected from farther off. Pressure transformers and valves controlling them can be engineered into connection with an actuator and/or a pressure transformer and/or connected from farther off with pressure medium conductors. The pressure transformation method and the apparatus implementing it can be employed in pressure-medium operated systems of new machines being engineered, but they can also be retrofitted in the actuators of used machines particularly engineered to speed up travel. A pressure medium transfer line allowing higher pressure or volume flow than the pressure and flow level allowed for the system is not usually required otherwise than between the actuator and the pressure transformers. The pressure transformers according to the invention can be connected such that pressure medium flowing from the actuator in the direction of the pressure transformer during the so-called return travel returns the operated pressure transformer or pressure transformers to a standby position, whereby the pressure transformer is always ready to transform pressure as the travel in the other direction starts. The pressure transformers according to the invention can be connected such that apparatuses increasing pressure and/or flow rate are engineered to be connected in the travels of the actuator in one and/or both directions. When one or more pressure transformers are connected to the system to increase pressure, it is possible e.g. to drop the system pressure and still provide when required even higher force for the travel or portion of travel of the actuator than earlier with the higher pressure of the system. When the pressure transformers are connected to the system to increase flow rate, it is possible to provide quicker strokes for the travel or portions of travel of the actuator but, if required, the actuator has the same force in accordance with the system pressure. It is also possible to connect to the same system and/or to one or more actuators one or more flow rate increasing and/or pressure increasing transformers dimensioned in accordance with the location and desired task. By connecting pressure transformers engineered with various area ratios in parallel in accordance with the task requirement of the actuator, the actuator and/or travel portions are provided with different rates and forces and, when required, it is possible to use e.g. a pilot-controlled check valve in the pressure medium line between the pressure transformers to prevent e.g. the return of the one operated first of the transformers connected in parallel, a transformer of different area ratio starting to move.

The novel kinds of technical, mechanical and hydraulic arrangements entailed by the invention make the manufacture of the pressure transformer so light and the number of required hydraulic connections so small that it enables locating the pressure transformer as an auxiliary device to different kinds of existing and new hydraulic systems quickly and inexpensively as well as enables the use of the pressure transformer for the requirements of vehicles and industry. By employing pressure transformers according to the invention, it is possible to provide e.g. with a smaller hydraulic cylinder from a lower-pressure system a higher force than the pressure level of the system would enable when some travel or travel portion such requires. Furthermore, the pressure transformers according to the invention can be utilised for maximising travel speed, if e.g. force is required for only a portion of the travel distance of work done, by dimensioning the cylinder and the pressure transformer and/or transformers in a way required by the force requirement of the system and the work done. It is also possible to use the pressure transformers according to the invention in motor drives operated by a hydraulic motor or other pressure medium in which the motor is momentarily required higher forces and/or speeds than the pressure-flow level of the system would enable. The pressure transformers according to the invention can be manufactured with various pressure transformation coefficients and volumes required by the target. Location or some other reason demanding, a pressure transformer having the same volume and the same area ratio can be manufactured long and thin or thick and short or it is possible to perform a substantially similar pressure transformation task by dimensioning suitably several pressure transformers and by connecting them in parallel and/or in series. When operating, the pressure transformer according to the invention transforms e.g. the pressure/flow rate of medium flowing in a machine element, such as a hydraulic cylinder, requiring higher pressure in the ratio of its areas. The pressure transformer according to the invention can be provided with an adjustable sequence, over centre or some other, e.g. pressure-controlled, valve, which valve switches the pressure transformer on or off until the pressure caused by load has increased or decreased to a set pressure level i.e. being above or below a set, specific limit value. It is possible to connect pressure transformers according to the invention in parallel and/or in series. Pressure transformers according to the invention engineered with various transformation coefficients and/or volumes can also be connected in the systems in parallel and/or in series. The pressure transformers according to the invention can be engineered to operate with different known valves which can be pressure-compensated and/or non-pressure-compensated, e.g. mechanical, electric, pressure medium actuated valves, and the operation of the above valves can be controlled with e.g. mechanical, electric and/or pressure medium actuated sensors, switches and spring loads being separate and/or engineered in connection with the valves. The pressure transformers according to the invention can be programmed to operate with various logic controls, whereby the device transforming pressure is switched on and/or off controlled by sensors connected to the logic control and/or time and/or moments of the work step programmed in the logic control. It is possible to connect the pressure transformers according to the invention such that one or more pressure transformers are switched on or off when going above or below a set limit value controlling the valves for a travel portion of an actuator and/or actuators which requires the transformation of travel speed or force. The pressure transformers according to the invention can also be employed in systems operating with various media.

Next, some advantageous embodiments of the invention will be discussed by means of enclosed examples.

For example in the so-called flying plate shears or pressing work machines and piece fasteners used in industry, a hydraulic cylinder or a pneumatic cylinder often makes a travel approaching the piece for most portion of its stroke and the actual force requirement is only momentary at the moment of cutting and/or holding the piece. These embodiments often tend to dimension the operations such that the above cutting, preforming and fastening work stages occur as quickly as possible, particularly in automated lines, whereby the line speed increases and more products are finished more quickly. Often, the cylinders are dimensioned in accordance with the highest force required, whereby high flow rates and/or high system pressures are required of even a single actuator connected in line to speed up the travel and/or increase the force, which causes greater and greater losses in the transfer of medium as the speed increases. The problem is common because, when increasing the speed or force of the work cycle of an existing hydraulic system, the original flow and/or pressure level of the system, dimensioned for the system is exceeded causing greater flow losses as the speed increases, and the increase in the system pressure level is often limited by the highest operating pressure allowed for the original components selected in the system.

In the forest industry, an advantageous embodiment of the pressure transformer according to the invention is e.g. a step-feeding and/or rotator-feeding harvester head which, when delimbing a tree, reaches for quite high speed for the delimbing knives in relation to the tree, whereby inertia of mass can be utilised in the delimbing and the time used for delimbing shortens but, at the point of largest branches, the travel often slows down or stops, whereby high force is required for cutting the branches. Particularly step-feeding delimbing requires higher force in the cylinder stroke usually at the point of branches on average about tenth of the distance of the total stroke of the cylinder and it is important for effectively performing the work that the delimbing motion is as quick as possible. However, the cylinder has conventionally been dimensioned in accordance with the maximum force requirement, whereby the travel speed is almost the same even in that portion which does not require high force. The same applies for the guillotine shear devices used in harvester heads, because smaller trees being cut do not require high force to break, but the cylinder is still dimensioned in accordance with the highest force required.

An advantageous embodiment of the pressure transformer according to the invention is e.g. pliers/cutter used by the firefighting crew and other equivalent press and guillotine shear devices which are often engineered to operate pneumatically and/or hydraulically.

### BRIEF DESCRIPTION OF THE DRAWINGS

The invention will now be described with reference to the accompanying drawings in which

FIG. 1 shows a flow chart of a pressure transformation device according to the invention,

FIG. 2 shows a second flow chart of a pressure transformation device according to the invention,

FIG. 3 shows a third flow chart of a pressure transformation device according to the invention,

FIG. 4 shows a fourth flow chart of a pressure transformation device according to the invention,

FIG. 5 shows a fifth flow chart of a pressure transformation device according to the invention,

FIG. 6 shows a sixth flow chart of a pressure transformation device according to the invention, and

FIG. 7 shows a seventh flow chart of a pressure transformation device according to the invention.

### DETAILED DESCRIPTION

The figures show by means of examples various connections into hydraulic systems according to the invention. They include the following parts or elements: hydraulic cylinder 1, directional control valve 2, hydraulic power unit 3, pressure transformation cylinder 4, sequence valves 5, 6, 7 and check valve 8.

Valves 5, 6 and 7 are generally called sequence valves, because the valves phase the operations. Valves in accordance with the figures can be suitably engineered of commonly known components, but it is possible to engineer the same phasing operations with various suitably known arrangements.

FIG. 1 shows a pressure transformation device in which a pressure transformer 4 increases pressure for the ratio of areas to a hydraulic cylinder 1 being the actuator. Furthermore, the figure shows a sequence valve 5 and a pilot-controlled sequence valve 6 to control the operation of the pressure transformer 4. The figure also shows a directional control valve 2 and a hydraulic power unit 3 to describe the operation. The directional control valve 2 being in the position shown by the figure, the hydraulic cylinder 1 has returned to its closed position. Oil has been able to flow freely into a tank via a check valve in the sequence valve 5 if the arm of the pressure transformer 4 was out of the cylinder as the travel started. The piston of the pressure transformer 4 having entered totally, pressure in a line B has increased and a pilot channel has opened the sequence valve 6, whereby the rest of oil has been able to exit the hydraulic cylinder 1 via the directional control valve 2 into the tank. When transferring the directional control valve 2 to another position, whereby the volume flow produced by the power unit 3 can enter a channel A, oil is able to flow via the check valve of the pilot-controlled sequence valve 6 into the cylinder 1. The cylinder 1 starts the travel with normal oil flow produced by the hydraulic power unit 3. If the load increases or is so great that pressure in a line A increases and the pressure exceeds the pressure value set for the sequence valve 5, the sequence valve 5 opens and oil flows into the pressure transformer 4. The pressure transformer increases the pressure coming from the channel A in the ratio of its areas and oil pressurised higher than the system pressure of the hydraulic power unit escaping onto the arm side of the pressure transformer 4 tries to use the cylinder 1 at a pressure higher for the ratio of its areas but also at a flow rate lower for the ratio of its areas.

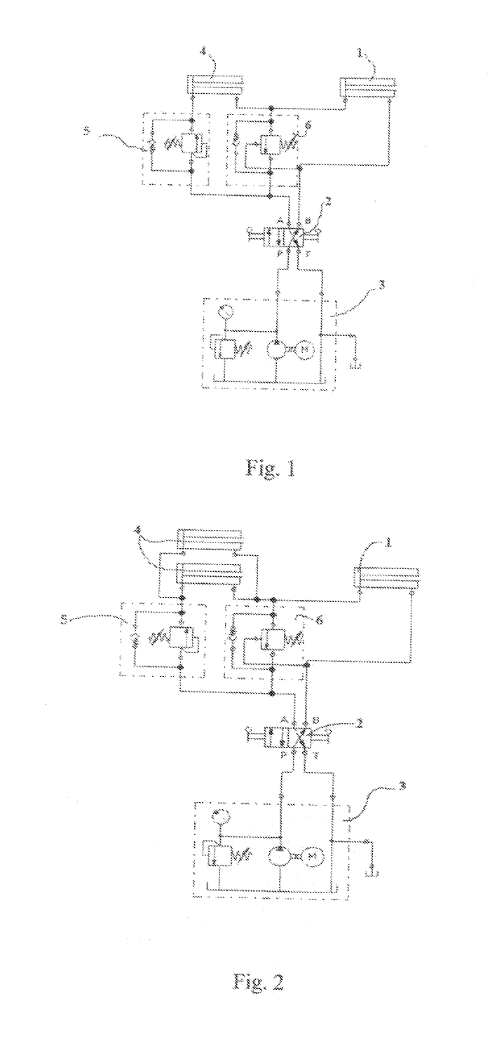

The structure and operation of the pressure transformation device according to FIG. 2 are otherwise similar to FIG. 1, but two pressure transformers 4 are connected in parallel in the system. The volumes and area ratios of the pressure transformers 4 can be similar or different, which facilitates their location depending on the target of use. This arrangement can also optimise the ratio of force and travel speed required by the target of use of the actuator 1. By connecting pressure transformers engineered with different area ratios in parallel in accordance with the task requirement of the actuator, the actuator is provided with various speeds and forces. When required, it is also possible to use e.g. a pilot-controlled check valve 8 in the pressure medium line between the pressure transformers to prevent e.g. the return of the first of the transformers connected in parallel, a transformer with a different area ratio starting to move.

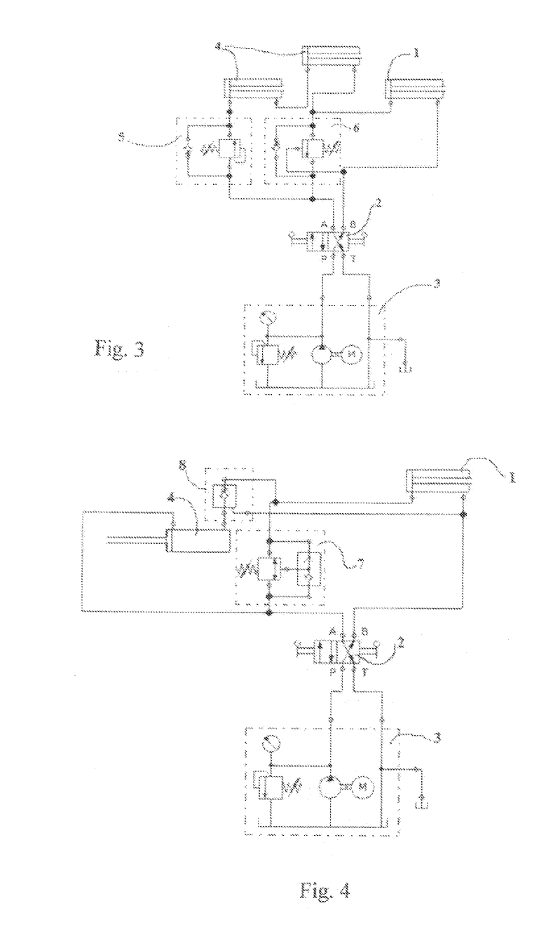

The structure and operation of the pressure transformation device according to FIG. 3 are otherwise similar to FIG. 1, but two pressure transformers 4 are connected in series in the system. If the load increases or is so great that pressure in the line A increases and the pressure exceeds the pressure value set for the sequence valve 5, the sequence valve 5 opens and oil flows into the pressure transformer 4 connected first in line. The pressure transformer 4 connected first in line increases the pressure coming from the channel A for the ratio of its areas and oil escaping from the arm side of the pressure transformer 4 connected first in line flows into the pressure transformer connected next in series which further increases for the ratio of its areas the pressure of the pressure transformer connected first in line. The pressure transformer connected second in series tries to operate the actuator 1 with pressure higher for the ratio of areas of the pressure transformers, but also flow rate lower for the ratio of areas of the pressure transformers.

FIG. 4 shows a pressure transformation device in which the pressure transformer 4 decreases pressure for the ratio of areas to the hydraulic cylinder 1 being the actuator, but thus increases flow rate for the ratio of areas of the pressure transformer 4 to the hydraulic cylinder 1 being the actuator. When transferring the directional control valve 2 to another position, the volume flow produced by the power unit 3 can enter the channel A and oil is able to flow freely onto the arm side of the pressure transformer 4. If the load on the hydraulic cylinder 1 is so small that the set pressure value of the sequence valve 7 provided with a diverting valve is not exceeded, oil exiting the pressure transformer 4 flows freely with a higher flow rate for the ratio of areas via the check valve 8 into the hydraulic cylinder 1. If the load on the hydraulic cylinder 1 increases so great that the set pressure value of the sequence valve 7 is exceeded and oil is able to flow via the sequence valve 7, the check valve 8 closes and the hydraulic cylinder 1 uses the system pressure of the hydraulic power unit 3.

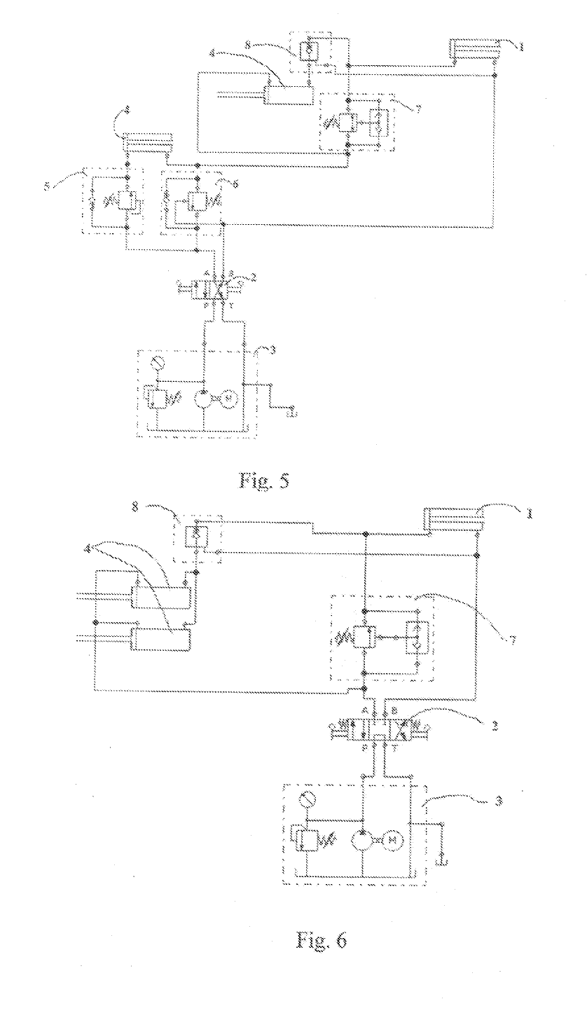

FIG. 5 shows a pressure transformation device which combines a pressure transformation unit similar to the one in FIG. 4, which decreases pressure for the ratio of areas to the hydraulic cylinder 1 being the actuator but thus increases the flow rate for the ratio of areas of the pressure transformer 4 to the hydraulic cylinder 1 being the actuator, with a pressure transformation unit according to FIG. 1 increasing pressure. When transferring the directional control valve 2 to another position, whereby the volume flow produced by the power unit 3 can enter the channel A, oil is able to flow freely via the sequence valve 6 onto the arm side of the pressure transformer 4. If the load on the hydraulic cylinder 1 is so small that the set pressure value of the sequence valve 7 provided with a change valve is not exceeded, oil exiting the pressure transformer 4 flows freely with a higher flow rate for the ratio of areas via the check valve 8 into the hydraulic cylinder 1. If the load on the actuator increases so great that the set pressure value of the sequence valve 7 is exceeded and oil is able to flow via the sequence valve 7, the check valve 8 closes and the actuator uses the system pressure of the hydraulic power unit 3. If the load increases or is so great that pressure in the line A increases and the pressure exceeds the pressure value set for the sequence valve 5, the sequence valve 5 opens and oil flows into the pressure transformer 4. The pressure transformer increases the pressure coming from the channel A in the ratio of its areas and oil pressurised higher than the system pressure of the hydraulic power unit escaping onto the arm side of the pressure transformer 4 tries to use the hydraulic cylinder 1 going via the sequence valve 7 provided with a change valve at a pressure higher for the ratio of its areas but also at a flow rate lower for the ratio of its areas.

FIG. 6 shows a pressure transformation device in which the pressure transformer 4 decreases pressure for the ratio of areas to the hydraulic cylinder 1 being the actuator, but thus increases flow rate for the ratio of areas of the pressure transformer 4 to the hydraulic cylinder 1 being the actuator. When the load of the hydraulic cylinder 1 does not exceed the opening pressure set for the sequence valve 7, medium flows from the line A into the pressure transformers 4 and via the check valve 8 into the hydraulic cylinder 1. If the load on the hydraulic cylinder 1 increases and exceeds the opening pressure set for the sequence valve 7, medium is able to enter the hydraulic cylinder 1 through the sequence valve 7 and closes the check valve 8. During the return travel of the hydraulic cylinder 1, the pressure transformer 4 having opened totally or partially ensues that, during the return travel, medium from the line B flows into the hydraulic cylinder 1 and medium from the hydraulic cylinder 1 flows via the check valve 8 into the pressure transformers 4 and via the line A into the tank. If the hydraulic cylinder 1 has not totally closed during the return travel and the pressure transformer 4 has closed, the pressure of medium exiting the hydraulic cylinder 1 opens the sequence valve 7 and medium is able to exit along the line A into the tank. By connecting pressure transformers engineered with different area ratios in parallel in accordance with the task requirement of the actuator, the actuator is provided with various speeds and forces. When required, it is also possible to use e.g. a pilot-controlled check valve 8 in the pressure medium line between the pressure transformers to prevent e.g. the return of the first of the transformers connected in parallel, a transformer with a different area ratio starting to move.

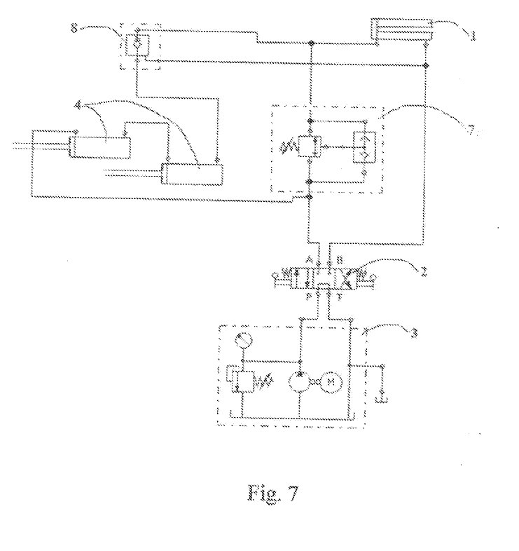

FIG. 7 shows a pressure transformation device in which the pressure transformer 4 decreases pressure for the ratio of areas to the hydraulic cylinder 1 being the actuator, but thus increases flow rate for the ratio of areas of the pressure transformer 4 to the hydraulic cylinder 1 being the actuator. When transferring the directional control valve 2 to another position, the volume flow produced by the power unit 3 can enter the channel A and oil is able to flow freely onto the arm side of the pressure transformer 4 first in series and from there second in series transforming the pressure for the ratio of its areas. If the load on the hydraulic cylinder 1 is so small that the set pressure value of the sequence valve 7 provided with a change valve is not exceeded, oil exiting the pressure transformer 4 flows freely with a higher flow rate for the ratio of areas via the check valve 8 into the hydraulic cylinder 1. If the load on the hydraulic cylinder 1 increases so great that the set pressure value of the sequence valve 7 is exceeded and oil is able to flow via the sequence valve 7, the check valve 8 closes and the hydraulic cylinder 1 uses the system pressure of the hydraulic power unit 3.

Above, the invention was described by way of examples by means of the enclosed schematic drawings, different embodiments of the invention being possible within the scope of the inventive idea defined by the claims. The flow of pressure medium is controllable with various suitably known valves and their operation is controllable with various suitably known arrangements, whereby the invention is not limited to the described advantageous embodiments and figures, but it can vary within the scope of the claims.

What is claimed is:

1. A method for transforming the pressures of a system operating with pressure medium to optimise the travel speeds and/or forces of tasks utilising pressure, area and flow ratios, employing valve structures, in which method, transforming with one or more pressure transformers the pressure of one or more actuators to differ from system pressure, comprising one or more double-acting pressure transformation cylinders switching on or off when going above or below a set known limit value controlling valves for a travel portion of one or more double-acting actuators which requires transforming travel speed or force.

2. A method according to claim 1, further comprising connecting double-acting pressure transformation cylinders for one or several double-acting actuators one or several common or one or several double-acting actuator-specifically.

3. A method according to claim 1, further comprising arranging pressure medium flowing from double-acting actuator in the direction of the double-acting pressure transformation cylinders to return one or more double-acting pressure transformation cylinders operated to a standby position.

4. A method according to claim 1, further comprising performing a single substantially similar pressure transformation task with one or more different and/or similar double-acting pressure transformation cylinders by connecting several pressure transformers to the double-acting actuator in parallel and/or in series to perform the task.

5. A method according to claim 1, further comprising connecting double-acting pressure transformation cylinders engineered with various area ratios in parallel according to the task requirement of the double-acting actuator to provide one or more double-acting actuators and/or travel portions with several speeds and forces.

6. A method according to claim 1, further comprising connecting the double-acting pressure transformation cylinders to increase pressure and/or flow rate in the travels of one or more double-acting actuators in one and/or both directions.

7. A device implementing the method according to claim 1, which comprises;
valve structures; and
one or more double-acting pressure transformation cylinders for transforming the pressure of a double-acting actuator to differ from system pressure, wherein one or more double-acting pressure transformation cylinders are arranged to switch on or off when going above or below a set limit value controlling valves for that travel portion of the actuator which requires higher travel speed or force.

8. A device according to claim 7, wherein one or more double-acting pressure transformation cylinders are engineered to operate with various known the time- or pressure- or flow controlled valves, and that the valves are arranged to operate with various different known sensors and switches controlling them.

9. An apparatus implementing the method according to claim 1, wherein one or more apparatuses increasing pressure or flow rate are connected in the system for at least one double-acting actuator in parallel and/or in series.

10. An apparatus implementing the method according to claim 1, wherein apparatuses increasing pressure and/or flow rate are engineered to be connected in the travels of the double-acting actuator in one and/or both directions.
